(19) United States
(12) Patent Application Publication
(10) Pub. No.: US 2026/0186435 A1
(43) Pub. Date: Jul. 2, 2026

(54) FIXATION SYSTEM AND IMAGE FORMING APPARATUS

(71) Applicant: FUJIFILM Business Innovation Corp., Tokyo (JP)

(72) Inventors: Toshiyuki MIYATA, Kanagawa (JP); Tatsuki SANO, Kanagawa (JP); Shimpei TAKAGI, Kanagawa (JP); Kosaku YOSHIMURA, Kanagawa (JP); Hiroki OGURA, Kanagawa (JP); Hitoshi KOMURO, Kanagawa (JP); Keitaro MORI, Kanagawa (JP)

(73) Assignee: FUJIFILM Business Innovation Corp., Tokyo (JP)

(21) Appl. No.: 19/305,535

(22) Filed: Aug. 20, 2025

(30) Foreign Application Priority Data
Dec. 27, 2024 (JP) 2024-232974

(51) Int. Cl. G03G 15/20

(52) U.S. Cl. CPC G03G 15/205; G03G 15/2025; G03G 15/2064; G03G 2215/2035

(57) ABSTRACT

A fixation system includes a rotating body; a fixation belt that is formed in endless and forms a fixation nip where an image on a medium is fixed by making contact with the rotating body; a heater that makes contact with an inner circumference of a portion of the fixation belt where the fixation nip is formed with a lubricant interposed therebetween and heats the fixation belt; and a processor configured to: execute a leveling mode in which the fixation belt is rotated while causing the heater to heat the fixation belt at a temperature higher than a fixation temperature used during fixation of the image on the medium.

### CROSS-REFERENCE TO RELATED APPLICATIONS

This application is based on and claims priority under 35 USC 119 from Japanese Patent Application No. 2024-232974 filed Dec. 27, 2024.

### BACKGROUND

### (i) Technical Field

The present disclosure relates to a fixation system and an image forming apparatus.

### (ii) Related Art

Japanese Unexamined Patent Application Publication No. 2017-138422 discloses an interchangeable fixation device including a rotatable fixation member having a low heat capacity, a rotary member that rotates in press contact with an outer surface of the fixation member, a nip formation member that comes into press contact with an inner surface of the fixation member at a position opposing the rotary member to form a nip part, and a lubricant in a sliding part between the fixation member and the nip formation member, in which a non-fixed toner image is fixed on a recording medium by application of heat and pressure while holding and conveying the recording material by the nip part, and the fixation device includes at least one or more temperature detection elements detecting a temperature of the fixation member or the nip formation member, and a controller that controls timing of suspending the fixation device in accordance with a temperature detection result of the temperature detection element in a rotation mode for smoothing the lubricant which is executed at a predetermined timing separately from a printing operation of the fixation device.

### SUMMARY

Aspects of non-limiting embodiments of the present disclosure relate to a technique of suppressing defective fixation on a medium as compared with a configuration in which only a fixation mode for fixing an image on a medium is executed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixation system including a rotating body; a fixation belt that is formed in endless and forms a fixation nip where an image on a medium is fixed by making contact with the rotating body; a heater that makes contact with an inner circumference of a portion of the fixation belt where the fixation nip is formed with a lubricant interposed therebetween and heats the fixation belt; and a processor configured to: execute a leveling mode in which the fixation belt is rotated while causing the heater to heat the fixation belt at a temperature higher than a fixation temperature used during fixation of the image on the medium.

### BRIEF DESCRIPTION OF THE DRAWINGS

An exemplary embodiment of the present disclosure will be described in detail based on the following figures, wherein:

FIG. 1 is a schematic configuration diagram illustrating an image forming apparatus according to the present exemplary embodiment;

FIG. 2 is a block diagram illustrating a hardware configuration of a controller according to the present exemplary embodiment;

FIG. 3 is a front cross-sectional view illustrating a state where a pressure roll is separated from a fixation belt in a fixation system according to the present exemplary embodiment;

FIG. 4 is a front cross-sectional view illustrating a state where the pressure roll is pressed against the fixation belt in the fixation system according to the present exemplary embodiment;

FIG. 5 is a flowchart illustrating modes executable by the controller according to the present exemplary embodiment; and

FIG. 6 is a flowchart of a case where the controller according to the present exemplary embodiment executes a leveling mode.

### DETAILED DESCRIPTION

### Exemplary Embodiment

An example of a fixation system and an image forming apparatus according to an exemplary embodiment of the present disclosure (present exemplary embodiment) is described with reference to the drawings.

In the drawings, arrow H indicates an up-down direction of the image forming apparatus, and arrow W indicates a width direction of the image forming apparatus. The up-down direction of the image forming apparatus and the width direction of the image forming apparatus are orthogonal to each other. These directions are directions decided for convenience of description, and therefore the configuration of the image forming apparatus is not limited to these directions. When a direction of the image forming apparatus is mentioned, the word “image forming apparatus” may be omitted. The +R direction is a counterclockwise rotating direction about a direction (depth direction) orthogonal to the up-down direction and the width direction. The −R direction is a clockwise rotating direction about the depth direction.

### Image Forming Apparatus

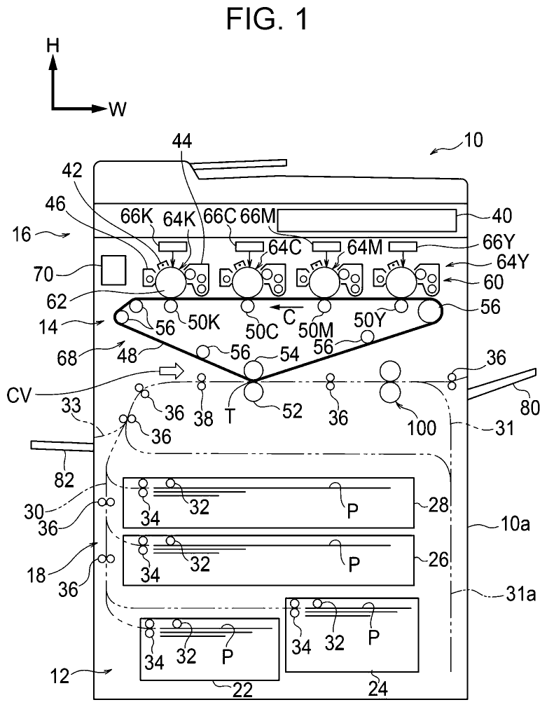

An image forming apparatus 10 forms an image on a sheet member P. The sheet member P is an example of a medium. As illustrated in FIG. 1, in the image forming apparatus 10, each part is disposed inside an apparatus body 10a. The image forming apparatus 10 includes a paper storage part 12, an operating part 14, a transport part 18, and a controller 70. The image forming apparatus 10 further includes a display part 40 as an interface used by a user to exchange information with the image forming apparatus 10.

### Paper Storage Part

The paper storage part 12 stores the sheet member P therein. The paper storage part 12 includes a first storage part 22, a second storage part 24, a third storage part 26, and a fourth storage part 28. The sheet members P having different sizes are stored as appropriate in the first storage part 22, the second storage part 24, the third storage part 26, and the fourth storage part 28. The first storage part 22, the second storage part 24, the third storage part 26, and the fourth storage part 28 each include a feeding roll 32 and a double feed prevention roll 34. The feeding roll 32 feeds the stored sheet members P one by one on the basis of an instruction from the controller 70 that manages operation of each part. The double feed prevention roll 34 transports the sheet members P fed by the feeding roll 32 to a transport path 30 in the image forming apparatus 10 one by one.

### Operating Part

The operating part 14 outputs image data sent from a user terminal (not illustrated) or a document reading part 16 to the sheet member P transported from the paper storage part 12. The operating part 14 includes an image former 60, a transfer unit 68, and a fixation device 100. The operating part 14 is an example of an image former.

The image former 60 forms a toner image. The toner image is an example of an image. The image former 60 includes image forming units 64K, 64C, 64M, and 64Y that form yellow (Y), magenta (M), cyan (C), and black (K) toner images. In the following description, Y, M, C, or K at the end of the reference sign may be omitted in a case where the image forming units 64K, 64C, 64M, and 64Y are not distinguished.

The image forming unit 64 includes a photoconductor drum 62, a charging device 42, a developing device 44, a cleaning member 46, and an exposure device 66 (66K, 66C, 66M, or 66Y). The charging device 42 charges the rotating photoconductor drum 62, and the exposure device 66 forms an electrostatic latent image by irradiating the charged photoconductor drum 62 with exposure light. Furthermore, the developing device 44 develops the electrostatic latent image to visualize the electrostatic latent image as a toner image. That is, the image forming apparatus 10 according to the present exemplary embodiment is an electrophotographic apparatus.

The transfer unit 68 transfers a toner image onto the sheet member P. The transfer unit 68 is located below the image former 60. The transfer unit 68 includes a transfer belt 48, a first transfer roll 50, a second transfer roll 52, an auxiliary roll 54, and rolls 56.

The transfer belt 48 is an endless belt, forms an upside-down triangle when viewed from the near side in the depth direction, and makes contact with the image former 60 from below in the up-down direction. The depth direction is a direction orthogonal to the up-down direction and the width direction.

The first transfer roll 50 (50K, 50C, 50M, or 50Y) has a cylindrical shape extending in the depth direction, is provided corresponding to the photoconductor drum 62, holds the transfer belt 48 together with the photoconductor drum 62, and transfers the toner image from the photoconductor drum 62 onto the transfer belt 48.

The second transfer roll 52 has a cylindrical shape extending in the depth direction, is provided below the first transfer roll 50, and transfers a toner image on the transfer belt 48 onto the sheet member P at a transfer position T.

The auxiliary roll 54 has a cylindrical shape extending in the depth direction, and is provided on an inner side of the transfer belt 48, that is, provided on a side opposite to the second transfer roll 52 across the transfer belt 48.

The plural rolls 56 are provided on the inner side of the transfer belt 48, and the transfer belt 48 is wound around the rolls 56. One of the rolls 56 functions as a drive roll that causes the transfer belt 48 to circulate in the direction indicated by arrow C in FIG. 1.

The fixation device 100 is located downstream of the transfer position T, and fixes, on the sheet member P, a toner image transferred onto the sheet member P. Details of the fixation device 100 will be described later.

### Transport Part

The transport part 18 receives the sheet members P transported from the double feed prevention roll 34 or fed from an outside of the apparatus body 10a and transports the sheet members P one by one. The transport part 18 includes the transport path 30, transport rolls 36, and a transport device 38.

The transport path 30 is a path that defines a transport direction of the sheet member P (hereinafter simply referred to as a “transport direction CV”).

An upstream portion of the transport path 30 extends upward on one side in the width direction. A manual feeding path 33 is connected to an upper end portion of the upstream portion of the transport path 30.

A downstream portion of the transport path 30 extends from one side to the other side in the width direction and leads to a discharge part 80 that discharges the sheet member P to the outside of the apparatus body 10a. A both-side transport path 31 where the sheet member P is transported and reversed to form an image on a rear surface of the sheet member P is connected to a downstream end portion of the transport path 30. The both-side transport path 31 includes a switchback path 31a, and the sheet member P reversed in the switchback path 31a is fed from the switchback path 31a to the upper end portion of the upstream portion of the transport path 30 in the transport direction CV.

The plural transport rolls 36 have a cylindrical shape extending in the depth direction and are provided along the transport path 30. The transport rolls 36 are provided as pairs in the apparatus body 10a so as to hold the transport path 30.

The transport device 38 is located upstream of the transfer position T in the transport direction CV, and stops the sheet member P once and sends the sheet member P to a second transfer position at a determined timing.

### Controller

The controller 70 is a computer that controls each part of the image forming apparatus 10.

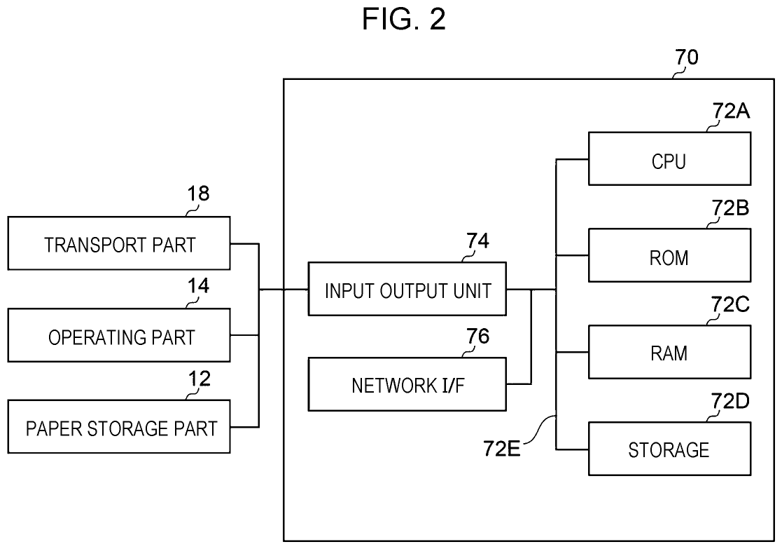

As illustrated in FIG. 2, the controller 70 includes a central processing unit (CPU) 72A, a read only memory (ROM) 72B, a random access memory (RAM) 72C, a storage 72D, an input output unit 74, and a network interface (network I/F) 76. The constituent elements are communicably connected to one another by a bus 72E.

The CPU 72A is a central processing unit, and executes various programs and controls each part. That is, the CPU 72A reads out a program from the ROM 72B or the storage 72D and executes the program while using the RAM 72C as a working area. The CPU 72A is an example of a processor that constitutes the fixation system. The CPU 72A controls the constituent elements and performs various kinds of arithmetic processing in accordance with a program stored in the ROM 72B or the storage.

The ROM 72B stores various programs and various data therein. The RAM 72C serves as a working area in which a program or data is temporarily stored. The storage 72D is a hard disk drive (HDD) or a solid state drive (SSD), and stores various programs including an operating system and various data therein.

The input output unit 74 receives signals among the constituent elements of the image forming apparatus 10 to accomplish functions of the image forming apparatus 10. For example, the input output unit 74 receives signals among the paper storage part 12, the operating part 14, and the transport part 18.

The network I/F 76 is an interface for communication with another apparatus such as a database or a server (not illustrated) and uses, for example, a standard such as Ethernet (Registered Trademark), FDDI, or Wi-Fi (Registered Trademark).

### Details of Fixation Device

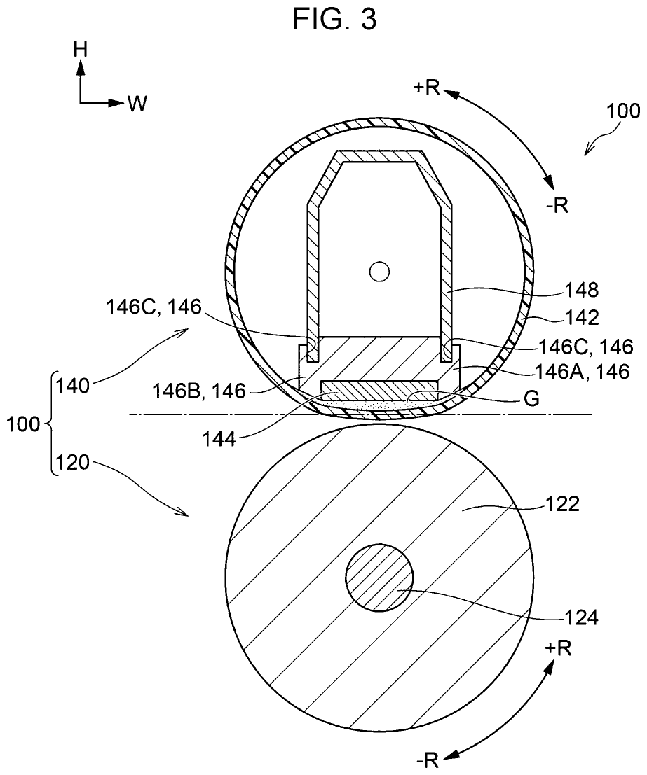

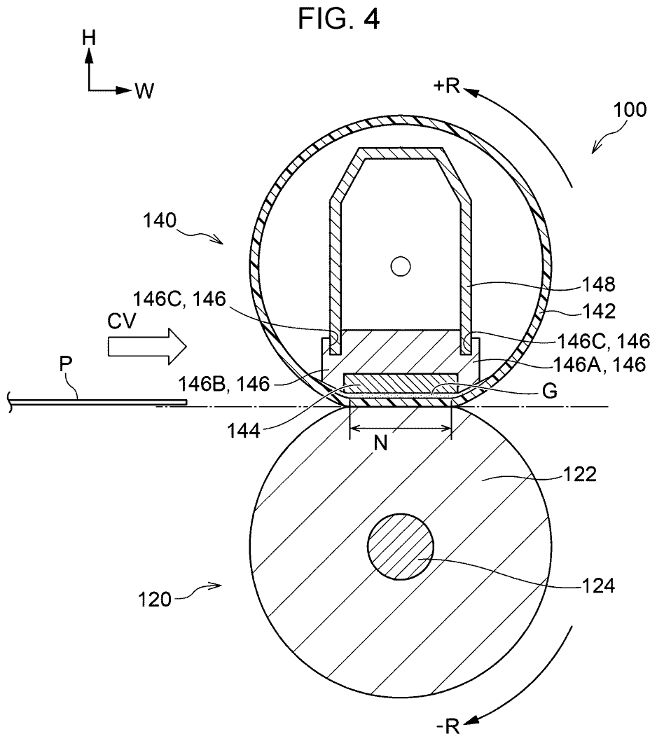

As illustrated in FIGS. 3 and 4, the fixation device 100 includes a pressure roll 120 and a heating part 140. In the fixation device 100, a toner image is fixed on the sheet member P by the pressure roll 120 and the heating part 140. Specifically, in the fixation device 100, a toner image transferred onto the sheet member P by the image former 60 is fixed on the sheet member P by heating and pressing the sheet member P transported from the image former 60. The fixation device 100 constitutes the fixation system together with the CPU 72A of the controller 70.

### Pressure Roll

The pressure roll 120 is a roll-shaped member extending in the depth direction. The pressure roll 120 is located below the transport path 30. The pressure roll 120 is rotatably supported on the apparatus body 10a, and is driven by a drive unit (not illustrated) to rotate in the +R direction and the −R direction. The pressure roll 120 is an example of a rotating body. The pressure roll 120 is separable from and contactable with the transport path 30 by a contact/separation mechanism (not illustrated). The pressure roll 120 is configured to apply pressure to the sheet member P.

The pressure roll 120 is a multilayer structure including a core bar 124, an elastic layer 122, and a release layer (not illustrated). The core bar 124 is a thin-walled cylinder made of a steel material and is supported on the apparatus body 10a. The elastic layer 122 is a layer containing silicone rubber or the like coating a surface of the core bar 124. The release layer (not illustrated) is a fluorocarbon resin layer coating a surface of the elastic layer 122.

### Heating Part

The heating part 140 is a structure extending in the depth direction. The heating part 140 is located above the transport path 30. The heating part 140 is configured to melt toner on the sheet member P. The heating part 140 includes the fixation belt 142, a heater 144, a pad 146, and a support member 148.

The fixation belt 142 is an endless belt whose axial direction is the depth direction. The fixation belt 142 has a release layer containing a fluorocarbon resin as needed on an outer circumferential surface of a thin-walled cylindrical base member made of a synthetic resin such as a polyimide resin or a polyamide-imide resin. The fixation belt 142 is rotatably supported on the apparatus body 10a. The fixation belt 142 rotates in the −R direction and the +R direction in a driven manner following rotation of the pressure roll 120 in a state where the pressure roll 120 is pressed against the fixation belt 142. For example, the fixation belt 142 rotates in the +R direction as the pressure roll 120 rotates in the −R direction in the state where the pressure roll 120 is pressed against the fixation belt 142.

The heater 144 is a planar heat generator that extends in the depth direction and is provided inside the fixation belt 142. The heater 144 makes contact with an inner circumference of the fixation belt 142 in a state where the pressure roll 120 is pressed against the fixation belt 142. A temperature of the heater 144 is adjustable on the basis of an instruction from the controller 70. The heater 144 heats the fixation belt 142 through the grease G.

The grease G is a lubricant that lowers sliding resistance between the fixation belt 142 and the heater 144 when held between the fixation belt 142 and the heater 144. The grease G is smaller in cone penetration than fluorine grease. For example, the grease G is 250 or less in worked penetration defined by JIS K 2220. Furthermore, viscosity of the grease G at 200° C. measured by a rheometer is 50 Pa·s to 1500 Pa·s. The viscosity of the grease G is preferably 80 Pa·s to 1000 Pa·s. The viscosity of the grease G is more preferably 100 Pa·s to 500 Pa·s. A weight decrease rate of the grease G stored under a heated condition at 230° C. for 336 hours is 0 wt % to 20 wt %. The weight decrease rate of the grease G is preferably 0 wt % to 15 wt %. The weight decrease rate of the grease G is more preferably 0 wt % to 10 wt %.

The grease G is a combination of base oil and a thickener. The base oil of the grease G is silicone oil and is preferably dimethyl silicone oil, methyl phenyl silicone oil, or diphenyl silicone oil, and a side chain may be partially introduced. A weight-average molecular weight Mw of the silicone oil is 10000 to 100000. The weight-average molecular weight Mw is preferably 10000 to 60000. The weight-average molecular weight Mw is more preferably 15000 to 40000.

As a component of the thickener of the grease G, one or more of inorganic materials such as melamine cyanurate, boron nitride, carbon black, silica, graphite, molybdenum disulfide, zinc stearate, and tungsten disulfide are selected. An average particle diameter (D50v) of the thickener is 0.01 μm to 15 μm. The average particle diameter is preferably 0.1 μm to 10 μm. The average particle diameter is more preferably 0.1 μm to 5 μm.

A weight ratio of the base oil in the components of the grease G is 40 wt % to 95 wt %. The weight ratio is preferably 50 wt % to 85 wt %. The weight ratio is more preferably 50 wt % to 75 wt %.

The viscosity of the grease G is measured by the following method. A grease sample is held between parallel plates having a diameter of 40 mm, and the viscosity is measured by using a dynamic mechanical analyzer (rheometer ARES-G2 produced by TA instruments) at a gap of 1 mm and an angular velocity of 0.1 rad/s while raising a temperature from 40° C. to 200° C. at a rate of 6° C./min.

To calculate the weight decrease rate of the grease G, 5 g of the grease sample is collected in an aluminum cup and is heated at 230° C. for 336 hours in an oven, and weights before and after the heating are examined.

The average particle diameter of the thickener is measured by the following method. 2 g of the grease sample is collected on filter paper and is filtered under suction after addition of 30 g of tetrahydrofuran (THF) to separate the base oil and the thickener. The separated thickener is dispersed in water, and a particle size distribution is measured by a particle size distribution measurement device (LS13320 produced by Beckman Coulter, Inc.).

The pad 146 is a block-shaped member that extends in the depth direction and is provided inside the fixation belt 142. The pad 146 supports the heater 144 so as to externally cover the heater 144 inside the fixation belt 142. That is, the pad 146 supports the heater 144 by an upstream side of a downstream end portion 146A in a fixation direction in which a toner image is fixed on the sheet member P and a downstream side of an upstream end portion 146B in the fixation direction. The pad 146 is disposed so that the downstream end portion 146A and the upstream end portion 146B make contact with the inner circumferential surface of the fixation belt 142 in a state where the pressure roll 120 is pressed against the fixation belt 142. The pad 146 is supported on the apparatus body 10a. The pad 146 causes an outer circumferential surface of the fixation belt 142 to face an outer circumferential surface of the pressure roll 120. The pad 146 further includes a recessed portion 146C. The recessed portion 146C is a recessed portion on a surface opposite to a support surface for the heater 144.

The support member 148 extends in the depth direction, is provided inside the fixation belt 142, and is a reversed-U-shaped frame when viewed from the depth direction. The support member 148 is supported on the apparatus body 10a. The support member 148 supports the pad 146 at the recessed portion 146C. The support member 148 receives pressing force of the pressure roll 120 via the heater 144 and the pad 146 in the state where the fixation belt 142 is pressed against the pressure roll 120.

### Fixation Nip

The fixation nip N is described. The fixation nip N is formed in a portion where the fixation belt 142 makes contact with the pressure roll 120 and fixes a toner image on the sheet member P. In the fixation nip N, the heater 144 heats the fixation belt 142 through the grease G. In other words, the heater 144 makes contact with an inner circumference of a portion of the fixation belt 142 where the fixation nip N is formed with the grease G interposed therebetween. In the fixation nip N, the heated fixation belt 142 melts toner on the sheet member P. Then, in the fixation nip N, the pressure roll 120 is pressed against the fixation belt 142 in a state where the sheet member P is held between the pressure roll 120 and the fixation belt 142. In this way, the toner image is fixed on the sheet member P in the fixation nip N.

### Modes

Two modes executed by the controller 70 are described. The two modes are a fixation mode and a leveling mode.

### Fixation Mode

The fixation mode is a mode executed when the image forming apparatus 10 forms an image. In the fixation mode, a toner image is fixed on the sheet member P on the basis of a fixation temperature and a fixation speed.

The fixation temperature is a predetermined temperature during fixation of a toner image on the sheet member P in the fixation nip. In the present exemplary embodiment, the fixation temperature is a command temperature from the controller 70 to the heater 144. For example, the fixation temperature is 180° C.

The fixation speed is a predetermined rotation speed during fixation of a toner image on the sheet member P. The fixation speed is set similar to a transport speed of the transport part 18. In the present exemplary embodiment, the fixation speed is a command speed from the controller 70 to the pressure roll 120. In the fixation mode, the pressure roll 120 rotates in the −R direction. Rotation of the pressure roll 120 in the −R direction is an example of a fixation direction.

### Leveling Mode

The leveling mode is a mode executed between image formation cycles of the image forming apparatus 10. The leveling mode is executed for the purpose of leveling non-uniformity (unevenness) of the grease G in the thickness direction in the fixation nip N. In the leveling mode, a leveling temperature, a first speed, and a second speed are considered.

The leveling temperature is set higher than the fixation temperature. In the present exemplary embodiment, the leveling temperature is a command temperature from the controller 70 to the heater 144 set on the basis of temperature characteristic of the grease G. For example, the leveling temperature is set higher than the fixation temperature by 20° C. Note that the leveling temperature is allowed to have a range.

The first speed is set lower than the fixation speed. For example, the first speed is 50% to 80% of the fixation speed. In the present exemplary embodiment, the first speed is a command speed from the controller 70 to the pressure roll 120. Note that the first speed is allowed to have a range.

The second speed is set higher than the fixation speed. For example, the second speed is 120% to 150% of the fixation speed. In the present exemplary embodiment, the first speed is a command speed from the controller 70 to the pressure roll 120. Note that the second speed is allowed to have a range. In the leveling mode, the fixation belt 142 is rotated at the first speed or the second speed.

In the leveling mode, unevenness of the grease G in the thickness direction is leveled by maintaining the first speed for a first period. The first period is an example of a predetermined period. The first period is, for example, 30 seconds.

### Flowchart

### Mode Determination

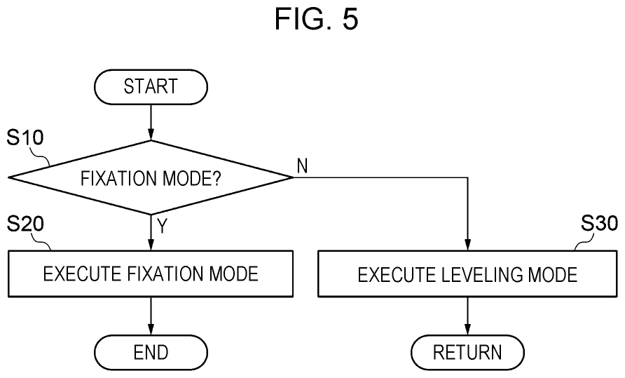

Switching of the mode of the controller 70 is described with reference to FIG. 5.

The CPU 72A of the controller 70 determines in step S10 whether or not the fixation mode is maintainable.

For example, in the following cases (i) to (iii), it is determined that the fixation mode is not maintainable, and the CPU 72A shifts to the leveling mode.
(i) case where the number of sheet members P on which an image has been formed by the image forming apparatus 10 has reached a predetermines number
(ii) case where a predetermined period has elapsed after image formation of the image forming apparatus 10
(iii) case where an instruction is received from a user (not illustrated) of the image forming apparatus 10

In a case where a result of the determination is “Y” meaning Yes, the CPU 72A proceeds to step S20. In step S20, the CPU 72A executes the fixation mode. Then, the CPU 72A ends the flow.

On the other hand, in a case where the result of the determination is “N” meaning No, the CPU 72A proceeds to step S30. In step S30, the CPU 72A executes the leveling mode. Then, the CPU 72A returns to the start of the flow.

In this way, the mode is switched.

### Execution of Leveling Mode

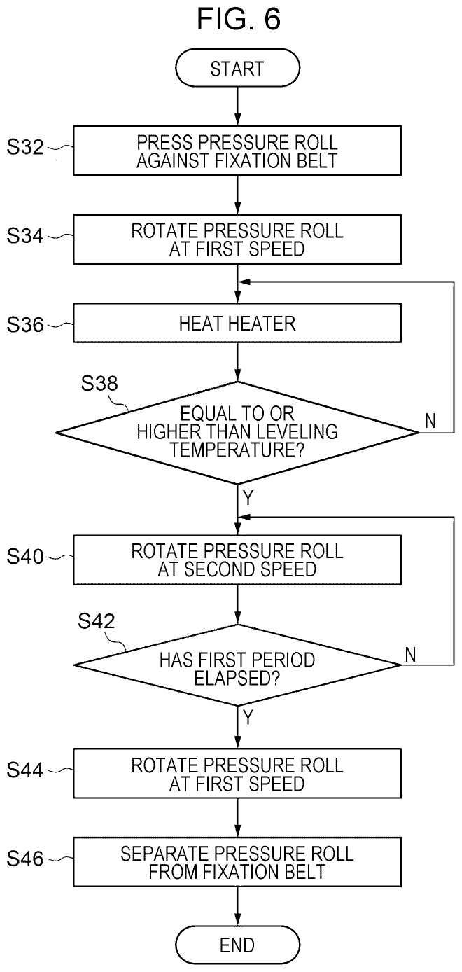

Next, execution of the leveling mode in the controller 70 is described with reference to FIG. 6. In the leveling mode according to the present exemplary embodiment, the controller 70 causes the fixation belt 142 to rotate in the +R direction in a driven manner by rotating the pressure roll 120 in the −R direction while causing the heater 144 to heat the fixation belt 142 at a temperature higher than the fixation temperature.

In step S32, the CPU 72A of the controller 70 causes the pressure roll 120 to be pressed against the fixation belt 142 by causing the contact/separation mechanism to switch the pressure roll 120 from the state illustrated in FIG. 3 to the state illustrated in FIG. 4. Then, the CPU 72A proceeds to step S34.

In step S34, the CPU 72A causes the drive unit to rotate the pressure roll 120 in the −R direction at the first speed. Then, the CPU 72A proceeds to step S36.

In step S36, the CPU 72A causes the heater 144 to heat the fixation belt 142. Then, the CPU 72A proceeds to step S38.

In step S38, the CPU 72A determines whether or not the temperature of the heater 144 is equal to or higher than the leveling temperature.

In a case where a result of the determination is “Y”, the CPU 72A proceeds to step S40.

On the other hand, in a case where the result of the determination is “N”, the CPU 72A proceeds to step S36. Then, the CPU 72A heats the heater 144 until the temperature of the heater 144 becomes equal to or higher than the leveling temperature.

In step S40, the CPU 72A causes the drive unit to rotate the pressure roll 120 in the −R direction at the second speed. That is, in the present exemplary embodiment, the CPU 72A causes the fixation belt 142 to rotate in the +R direction by rotating the pressure roll 120 in the −R direction at the second speed after the temperature of the heater 144 reaches the leveling temperature. Then, the CPU 72A proceeds to step S42.

In step S42, the CPU 72A determines whether or not a period for which the pressure roll 120 is rotated in the −R direction at the second speed has reached the first period.

In a case where a result of the determination is “Y”, the CPU 72A proceeds to step S44.

On the other hand, in a case where the result of the determination is “N”, the CPU 72A proceeds to step S40. Then, the CPU 72A continues to rotate the pressure roll 120 in the −R direction at the second speed until the first period elapses.

In step S44, the CPU 72A causes the drive unit to change the rotation speed of the pressure roll 120 from the second speed to the first speed. Then, the CPU 72A proceeds to step S46.

In the step S46, the CPU 72A causes the contact/separation mechanism to separate the pressure roll 120 from the fixation belt 142. Then, the CPU 72A ends the flow.

In this way, the leveling mode is executed.

### Modification

Although the present disclosure has been described in detail based on the specific exemplary embodiment, the present disclosure is not limited to the exemplary embodiment, and it is clear to a person skilled in the art that the present disclosure may take other various embodiments within the scope of the present disclosure.

Although the image forming apparatus 10 having the apparatus layout illustrated in FIG. 1 has been described in the above exemplary embodiment, this is not restrictive. For example, the present disclosure is also applicable to an image forming apparatus having an apparatus layout different from the image forming apparatus 10. Although the operating part 14 is a tandem color type in the above exemplary embodiment, this is not restrictive. The operating part may be a rotary type or may be a monochromatic type. Furthermore, the operating part is not limited to an indirect transfer type and may be a direct transfer type.

Although the CPU 72A causes the fixation belt 142 to rotate in the +R direction in a driven manner by rotating the pressure roll 120 in the −R direction in the leveling mode according to the above exemplary embodiment, this is not restrictive. For example, in step S34, step S40, or step S44 illustrated in FIG. 6, the CPU 72A may cause the fixation belt 142 to rotate in the −R direction in a driven manner by rotating the pressure roll 120 in the +R direction. Rotation of the fixation belt 142 in the −R direction is an example of rotation in a reverse direction or reverse rotation. According to this modification, defective fixation may be suppressed as compared with a case where during execution of the leveling mode, the fixation belt rotates only in a rotation direction identical to a rotation direction during fixation.

In the above modification, the CPU 72A may cause the fixation belt 142 to rotate in the −R direction in all of the periods where the fixation belt 142 is rotated during execution of the leveling mode. Rotation is an example of operation. That is, the CPU 72A may cause the fixation belt 142 to rotate in the −R direction in all of step S34, step S40, and step S44 during execution of the leveling mode. In this case, defective fixation may be suppressed as compared with a configuration in which the fixation belt is reversely rotated in one or some of the steps in which the fixation belt is rotated during execution of the leveling mode.

Although during execution of the leveling mode, the CPU 72A according to the above exemplary embodiment causes the fixation belt 142 to rotate at the second speed higher than the fixation speed used during fixation of a toner image, this is not restrictive. For example, in the leveling mode, the CPU 72A may cause the fixation belt 142 to rotate at a speed similar to the fixation speed or at the first speed.

Although the CPU 72A according to the above exemplary embodiment maintains rotation of the fixation belt 142 at the second speed for the first period during execution of the leveling mode, this is not restrictive. For example, the CPU 72A may maintain rotation of the fixation belt 142 at a speed equal to or lower than the fixation speed for the first period during execution of the leveling mode.

Although during execution of the leveling mode, the CPU 72A according to the above exemplary embodiment causes the fixation belt 142 to rotate while setting, as a target speed, the second speed higher than the fixation speed used during fixation of the toner image after the temperature of the heater 144 reaches the leveling temperature, this is not restrictive. For example, during execution of the leveling mode, the CPU 72A may start raising the rotation speed of the fixation belt 142 from the fixation speed to the second speed before the temperature of the heater 144 reaches the leveling temperature.

Although the fixation belt 142 rotates in the −R direction and the +R direction in a driven manner following rotation of the pressure roll 120 in the state where the pressure roll 120 is pressed against the fixation belt 142 in the above exemplary embodiment, this is not restrictive. For example, the pressure roll 120 may rotate in the −R direction and the +R direction in a driven manner following rotation of the fixation belt 142 in the state where the pressure roll 120 is pressed against the fixation belt 142.

Although the leveling temperature is a command temperature from the controller 70 to the heater 144 in the above exemplary embodiment, this is not restrictive. For example, as the leveling temperature, a temperature of an inner circumferential surface of the fixation belt 142 may be actually measured by a non-contact-type temperature sensor (not illustrated).

Although the CPU 72A causes the drive unit to change the rotation speed of the pressure roll 120 from the second speed to the first speed in step S44 in the above exemplary embodiment, this is not restrictive. For example, in step S44, the CPU 72A may cause the drive unit to change the rotation speed of the pressure roll 120 from the second speed to zero. That is, in step S44, the CPU 72A may stop rotation of the pressure roll 120.

In the above exemplary embodiment, the flow is not limited to the order illustrated in FIG. 6. For example, step S36 and step S34 may be exchanged. That is, the CPU 72A may rotate the pressure roll 120 after causing the heater 144 to heat the fixation belt 142.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program of the present application may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A fixation system including:
a rotating body;
a fixation belt that is formed in endless and forms a fixation nip where an image on a medium is fixed by making contact with the rotating body;
a heater that makes contact with an inner circumference of a portion of the fixation belt where the fixation nip is formed with a lubricant interposed therebetween and heats the fixation belt; and
a processor configured to:
execute a leveling mode in which the fixation belt is rotated while causing the heater to heat the fixation belt at a temperature higher than a fixation temperature used during fixation of the image on the medium.
(((2)))

The fixation system according to (((1))), in which
the processor is configured to, during execution of the leveling mode, rotate the fixation belt at a rotation speed higher than a fixation speed used during fixation of the image.
(((3)))

The fixation system according to (((2))), in which
the processor is configured to, during execution of the leveling mode, maintain the rotation of the fixation belt at the rotation speed higher than the fixation speed used during fixation of the image for a predetermined period.
(((4)))

The fixation system according to (((2))) or (((3))), in which
the processor is configured to, during execution of the leveling mode, rotate the fixation belt at the rotation speed higher than the fixation speed used during fixation of the image after a temperature of the heater reaches the temperature higher than the fixation temperature.
(((5)))

The fixation system according to any one of (((1))) to (((4))), in which
the processor is configured to, during execution of the leveling mode, rotate the fixation belt in a direction reverse to a rotation direction of the fixation belt during fixation of the image.
(((6)))

The fixation system according to (((5))), in which
the processor is configured to rotate the fixation belt in the reverse direction in all periods where the fixation belt operates in the leveling mode.
(((7)))

The fixation system according to any one of (((1))) to (((6))), in which
the lubricant is grease containing silicone oil as base oil and one or more thickeners selected from among inorganic particles and having worked penetration of 250 or less.
(((8)))

An image forming apparatus including:
an image former that forms an image on a medium; and
the fixation system according to any one of (((1))) to (((7))) that fixes the image on the medium.

What is claimed is:

1. A fixation system comprising:
a rotating body;
a fixation belt that is formed in endless and forms a fixation nip where an image on a medium is fixed by making contact with the rotating body;
a heater that makes contact with an inner circumference of a portion of the fixation belt where the fixation nip is formed with a lubricant interposed therebetween and heats the fixation belt; and
a processor configured to:
execute a leveling mode in which the fixation belt is rotated while causing the heater to heat the fixation belt at a temperature higher than a fixation temperature used during fixation of the image on the medium.

2. The fixation system according to claim 1, wherein
the processor is configured to, during execution of the leveling mode, rotate the fixation belt at a rotation speed higher than a fixation speed used during fixation of the image.

3. The fixation system according to claim 2, wherein
the processor is configured to, during execution of the leveling mode, maintain the rotation of the fixation belt at the rotation speed higher than the fixation speed used during fixation of the image for a predetermined period.

4. The fixation system according to claim 2, wherein
the processor is configured to, during execution of the leveling mode, rotate the fixation belt at the rotation speed higher than the fixation speed used during fixation of the image after a temperature of the heater reaches the temperature higher than the fixation temperature.

5. The fixation system according to claim 1, wherein
the processor is configured to, during execution of the leveling mode, rotate the fixation belt in a direction reverse to a rotation direction of the fixation belt during fixation of the image.

6. The fixation system according to claim 5, wherein
the processor is configured to rotate the fixation belt in the reverse direction in all periods where the fixation belt operates in the leveling mode.

7. The fixation system according to claim 1, wherein
the lubricant is grease containing silicone oil as base oil and one or more thickeners selected from among inorganic particles and having worked penetration of 250 or less.

8. An image forming apparatus comprising:
an image former that forms an image on a medium; and
the fixation system according to claim 1 that fixes the image on the medium.

9. An image forming apparatus comprising:
an image former that forms an image on a medium; and
the fixation system according to claim 2 that fixes the image on the medium.

10. An image forming apparatus comprising:
an image former that forms an image on a medium; and
the fixation system according to claim 3 that fixes the image on the medium.

11. An image forming apparatus comprising:
an image former that forms an image on a medium; and
the fixation system according to claim 4 that fixes the image on the medium.

12. An image forming apparatus comprising:
an image former that forms an image on a medium; and
the fixation system according to claim 5 that fixes the image on the medium.

13. An image forming apparatus comprising:
an image former that forms an image on a medium; and
the fixation system according to claim 6 that fixes the image on the medium.

14. An image forming apparatus comprising:
an image former that forms an image on a medium; and
the fixation system according to claim 7 that fixes the image on the medium.

15. A fixation system comprising:
rotating means;
endless fixation means for forming a fixation nip where an image on a medium is fixed by making contact with the rotating means;
heating means for heating the fixation means, the heating means making contact with an inner circumference of a portion of the fixation means where the fixation nip is formed with a lubricant interposed therebetween; and
means for executing a leveling mode in which the fixation means is rotated while causing the heating means to heat the fixation means at a temperature higher than a fixation temperature used during fixation of the image on the medium.
